(19) United States
(12) Patent Application Publication
(10) Pub. No.: US 2013/0010968 A1
(43) Pub. Date: Jan. 10, 2013

(54) Sound Processing Apparatus

(75) Inventors: Kosuke YAGI, Kawasaki-shi (JP); Hiroshi SARUWATARI, Ikoma-shi (JP); Yu TAKAHASHI, Hamamatsu-shi (JP)

(73) Assignee: YAMAHA CORPORATION, Hamamatsu-shi (JP)

(21) Appl. No.: 13/542,974

(22) Filed: Jul. 6, 2012

(30) Foreign Application Priority Data
Jul. 7, 2011 (JP) 2011-150819
Dec. 26, 2011 (JP) 2011-284075

(51) Int. Cl. H04R 5/00

(52) U.S. Cl. 381/17

(57) ABSTRACT

In a sound processing apparatus, a matrix factorization unit acquires a non-negative first basis matrix including a plurality of basis vectors that represent spectra of sound components of a first sound source, and acquires an observation matrix that represents time series of a spectrum of a sound signal corresponding to a mixed sound of the first sound source and a second sound source different from the first sound source. The matrix factorization unit generates a first coefficient matrix, a second basis matrix and a second coefficient matrix from the observation matrix by non-negative matrix factorization using the first basis matrix. A sound generation unit generates either of a sound signal according to the first basis matrix and the first coefficient matrix or a sound signal according to the second basis matrix and the second coefficient matrix.

### BACKGROUND OF THE INVENTION

1. Technical Field of the Invention

The present invention relates to a technology for separating sound signals by sound sources.

2. Description of the Related Art

A sound source separation technology for separating a mixed sound of a plurality of sounds respectively generated from different sound sources by the respective sound sources has been proposed. For example, Non-Patent Reference 1 and Non-Patent Reference 2 disclose an unsupervised sound source separation using non-negative matrix factorization (NMF).

In the technologies of Non-Patent Reference 1 and Non-Patent Reference 2, an observation matrix Y that represents the amplitude spectrogram of an observation sound corresponding to a mixture of a plurality of sounds is decomposed into a basis matrix H and a coefficient matrix U (activation matrix), as shown in FIG. 6 (Y≈HU). The basis matrix H includes a plurality of basis vectors h that represent spectra of components included in the observation sound and the coefficient matrix U includes a plurality of coefficient vectors u that represent time variations in magnitudes (weights) of the basis vectors. The amplitude spectrogram of a sound of a desired sound source is generated by separating the plurality of basis vectors h of the basis matrix H and the plurality of coefficient vectors u of the coefficient matrix U by respective sound sources, extracting a basis vector h and a coefficient vector u of the desired sound source and multiplying the extracted basis vector h by the extracted coefficient vector u.
[Non-Patent Reference 1] A. CICHOCKI, et. Al., “NEW ALGORITHMS FOR NON-NEGATIVE MATRIX FACTORIZATION IN APPLICATIONS TO BLIND SOURCE SEPARATION,” ICASSP 2006
[Non-Patent Reference 2] Tuomas Virtanen, “Monaural Sound Source Separation by Nonnegative Matrix Factorization With Temporal Continuity and Sparseness Criteria”, IEEE Trans. Audio, Speech and Language Processing, volume 15, pp. 1066-1074, 2007

However, the technologies of Non-Patent Reference 1 and Non-Patent Reference 2 have problems in that it is difficult to accurately separate (cluster) the plurality of basis vectors h of the basis matrix H and the plurality of coefficient vectors u of the coefficient matrix U by respective sound sources, and sounds of a plurality of sound sources may coexist in one basis vector h of the basis matrix H. Accordingly, it is difficult to separate a mixed sound of a plurality of sounds by respective sound sources with high accuracy. In view of this problem, an object of the present invention is to separate a mixed sound of a plurality of sounds by respective sound sources with high accuracy.

### SUMMARY OF THE INVENTION

The invention employs the following means in order to achieve the object. Although, in the following description, elements of the embodiments described later corresponding to elements of the invention are referenced in parentheses for better understanding, such parenthetical reference is not intended to limit the scope of the invention to the embodiments.

A sound processing apparatus of the invention comprises: a matrix factorization unit (for example, a matrix factorization unit 34) that acquires a non-negative first basis matrix (for example, a basis matrix F) including a plurality of basis vectors that represent spectra of sound components of a first sound source, and that acquires an observation matrix (for example, an observation matrix Y) that represents time series of a spectrum of a sound signal (for example, a sound signal SA(t)) corresponding to a mixed sound composed of a sound of the first sound source and a sound of a second sound source different from the first sound source, the matrix factorization unit generating a first coefficient matrix (for example, a coefficient matrix G) including a plurality of coefficient vectors that represent time variations in weights for the basis vectors of the first basis matrix, a second basis matrix (for example, a basis matrix H) including a plurality of basis vectors that represent spectra of sound components of the second sound source, and a second coefficient matrix (for example, a coefficient matrix U) including a plurality of coefficient vectors that represent time variations in weights for the basis vectors of the second basis matrix, from the observation matrix by non-negative matrix factorization using the first basis matrix; and a sound generation unit (for example, a sound generation unit 36) that generates at least one of a sound signal according to the first basis matrix and the first coefficient matrix and a sound signal according to the second basis matrix and the second coefficient matrix.

In this configuration, the first coefficient matrix of the first sound source and the second basis matrix and the second coefficient matrix of the second sound source are generated according to non-negative matrix factorization of an observation matrix using the known first basis matrix. That is, non-negative matrices (the first basis matrix and the first coefficient matrix) corresponding to the first sound source and non-negative matrices (the second basis matrix and the second coefficient matrix) corresponding to the second sound source are individually specified. Therefore, it is possible to separate a sound signal into components respectively corresponding to sound sources with high accuracy, in manner distinguished from Non-Patent Reference 1 and Non-Patent Reference 2.

The first sound source means a known sound source having the previously prepared first basis matrix whereas the second sound source means an unknown sound source, which differs from the first sound source. When only the first basis matrix of the first sound source is used for non-negative matrix factorization, a sound source corresponding to a sound other than the first sound source, from among sounds constituting a sound signal, corresponds to the second sound source. When basis matrices of a plurality of known sound sources, including the first basis matrix of the first sound source, are used for non-negative matrix factorization, a sound source corresponding to a sound other than the plurality of known sound sources including the first sound source, from among sounds constituting a sound signal, corresponds to the second sound source. The second sound source includes a sound source group to which two or more sound sources belong as well as a single sound source.

In a preferred aspect of the present invention, the matrix factorization unit may generate the first coefficient matrix, the second basis matrix and the second coefficient matrix under constraints that a similarity between the first basis matrix and the second basis matrix decreases (ideally, the first basis matrix and the second basis matrix are uncorrelated to each other, or a distance between the first basis matrix and the second basis matrix becomes maximum). In this aspect, since the first coefficient matrix, the second basis matrix and the second coefficient matrix are generated such that the similarity (for example in terms of correlation or distance) between the first basis matrix and the second basis matrix decreases, basis vectors corresponding to the basis vectors of the known first basis matrix are present in the second basis matrix so as to decrease the possibility that the coefficient vectors of one of the first coefficient matrix and the second coefficient matrix become zero vectors. Accordingly, it is possible to prevent omission of a sound from a sound signal after being separated. A detailed example of this aspect of the invention will be described below as a second embodiment.

In a different aspect, the second basis matrix generated by the matrix factorization unit and the first basis matrix acquired from a storage device (24) by the matrix factorization unit are not similar to each other. There is non-similarity between the acquired first basis matrix and the generated second basis matrix. The non-similarity means that the generated second basis matrix is not correlated to the acquired first basis matrix (there is uncorrelation between the first basis matrix and the second basis matrix) or otherwise means that a distance between the generated second basis matrix and the acquired first basis matrix is made maximum. The uncorrelated state includes not only a state where the correlation between the first basis matrix and the second basis matrix is minimum, but also a state where the correlation is substantially minimum. The state of substantially minimum correlation is meant to realize separation of the first sound source and the second sound source at a target accuracy. The separation enables generation of a sound signal of a sound of the first sound source or the second sound source. The target accuracy means a reasonable accuracy determined according to application or specification of the sound processing apparatus.

In similar manner, the state where the distance between the first basis matrix and the second basis matrix is maximum includes not only a state where the distance is maximum, but also a state where the distance is substantially maximum. The state of substantially maximum distance is meant to be a sufficient condition for realizing separation of the first sound source and the second sound source at the target accuracy.

In an aspect, the matrix factorization unit may generate the first coefficient matrix, the second basis matrix and the second coefficient matrix by repetitive computation of an update formula (for example, equation (12A)) which is set such that an evaluation function including an error term (for example, a first term ∥Y−FG−HU∥_{Fr}² of expression (3A)), which represents a degree of difference between the observation matrix and a sum of the product of the first basis matrix and the first coefficient matrix and the product of the second basis matrix and the second coefficient matrix, and a correlation term (for example, a second term ∥F^{T}H∥_{Fr}² of expression (3A) and a second term δ(F|H) of expression (3C)), which represents a degree of similarity (for example in terms of correlation or distance) between the first basis matrix and the second basis matrix, converges. In this aspect, it is possible to separate sounds of respective sound sources, which are included in a sound signal before being separated, with high accuracy while restraining partial omission of the sounds.

In another aspect, the matrix factorization unit generates the first coefficient matrix, the second basis matrix and the second coefficient matrix by repetitive computation of an update formula which is set such as to decease an evaluation function thereof below a predetermined value, the evaluation function including an error term and a correlation term, the error term representing a degree of difference between the observation matrix and a sum of the product of the first basis matrix and the first coefficient matrix and the product of the second basis matrix and the second coefficient matrix, the correlation term representing a degree of a similarity between the first basis matrix and the second basis matrix.

The predetermined value serving as a threshold value for the evaluation function is experimentally or statistically determined to a numerical value for ensuring that the evaluation function converges. For example, the relation between the repetition number of computation of the evaluation function and the numerical value of the computed evaluation function is analyzed, and the predetermined value is set according to results of the analysis such that it is reasonably determined that the evaluation function converges when the numerical value of the evaluation function becomes lower than the predetermined value.

In a preferable aspect of the invention, the matrix factorization unit may generate the first coefficient matrix, the second basis matrix and the second coefficient matrix by repetitive computation of an update formula (for example, expression (12B)) which is selected such that an evaluation function (for example, evaluation function J of expression (3B)) in which at least one of an error term and a correlation term has been adjusted using an adjustment factor (for example, adjustment factor λ) converges. In this aspect, since at least one of the error term and the correlation term of the evaluation function is adjusted using the adjustment factor in such a manner that values of the error term and the correlation term become close to each other, conditions for both the error term and the correlation term become compatible at a high level and accurate sound source separation can be achieved. A detailed example of this aspect will be described below as a third embodiment of the invention.

The sound processing apparatus according to each of the aspects may not only be implemented by dedicated hardware (electronic circuitry) such as a Digital Signal Processor (DSP) but may also be implemented through cooperation of a general operation processing device such as a Central Processing Unit (CPU) with a program. The program according to the invention allows a computer to perform sound processing comprising: acquiring a non-negative first basis matrix including a plurality of basis vectors that represent spectra of sound components a first sound source; generating a first coefficient matrix including a plurality of coefficient vectors that represent time variations in weights for the basis vectors of the first basis matrix, a second basis matrix including a plurality of basis vectors that represent spectra of sound components of a second sound source different from the first sound source, and a second coefficient matrix including a plurality of coefficient vectors that represent time variations in weights for the basis vectors of the second basis matrix, from an observation matrix that represents time series of a spectrum of a sound signal corresponding to a mixed sound composed of a sound of the first sound source and a sound of the second sound source according to non-negative matrix factorization using the first basis matrix; and generating at least one of a sound signal according to the first basis matrix and the first coefficient matrix and a sound signal according to the second basis matrix and the second coefficient matrix.

According to this program, it is possible to implement the same operation and effect as those of the sound processing apparatus according to the invention. Furthermore, the program according to the invention may be provided to a user through a computer readable non-transitory recording medium storing the program and then installed on a computer and may also be provided from a server device to a user through distribution over a communication network and then installed on a computer.

### BRIEF DESCRIPTION OF THE DRAWINGS

FIG. 1 is a block diagram of a sound processing apparatus according to a first embodiment of the invention.

FIG. 2 illustrates generation of a basis matrix F.

FIG. 3 illustrates an operation of a matrix factorization unit.

FIGS. 4(A)-4(D) illustrate effects of a second embodiment of the invention.

FIG. 5 illustrates effects of a second embodiment of the invention.

FIG. 6 illustrates conventional non-negative matrix factorization.

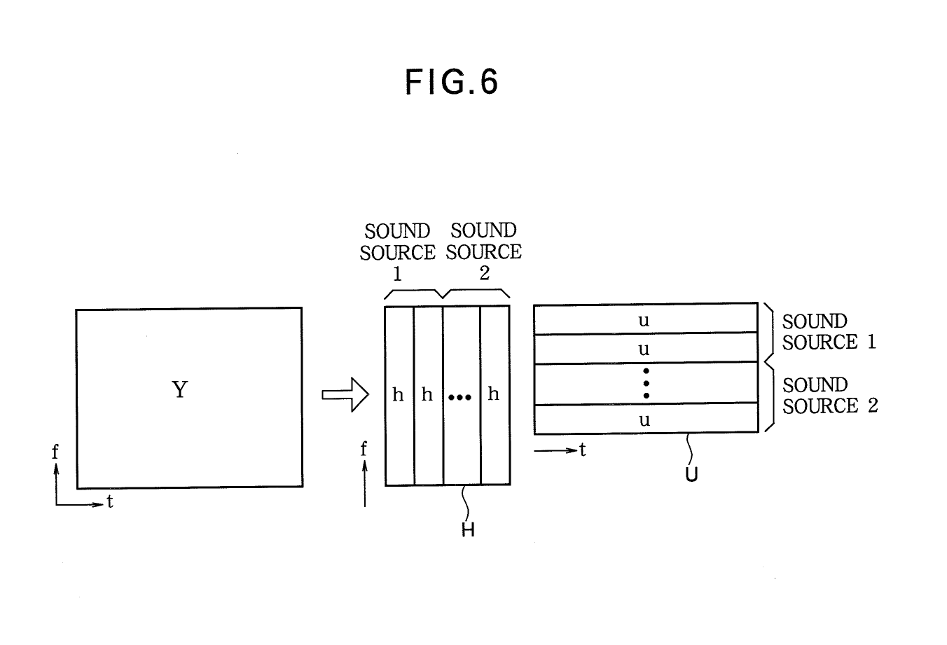

### DETAILED DESCRIPTION OF THE INVENTION

### First Embodiment

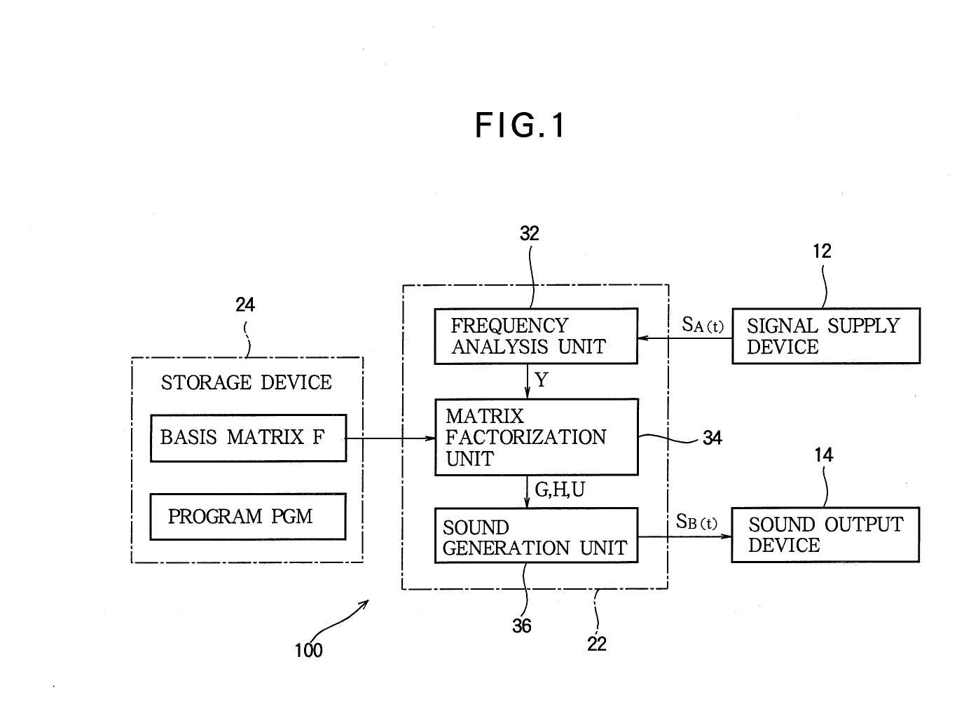

FIG. 1 is a block diagram of a sound processing apparatus 100 according to a first embodiment of the present invention. Referring to FIG. 1, the sound processing apparatus 100 is connected to a signal supply device 12 and a sound output device 14. The signal supply device 12 supplies a sound signal SA(t) to the sound processing apparatus 100. The sound signal SA(t) represents the time waveform of a mixed sound composed of sounds (musical tones or voices) respectively generated from different sound sources. Hereinafter, a known sound source from among a plurality of sound sources which generate sounds constituting the sound signal SA(t) is referred to as a first sound source and a sound source other than the first sound source is referred to as a second sound source. When the sound signal SA(t) is composed of sounds generated from two sound sources, the second sound source corresponds to the sound source other than the first sound source. When the sound signal SA(t) is composed of sounds generated from three or more sound sources, the second sound source means two or more sound sources (sound source group) other than the first sound source. It is possible to employ a sound collecting device that collects surrounding sound to generate the sound signal SA(t), a playback device that acquires the sound signal SA(t) from a portable or embedded recording medium and supplies the sound signal SA(t) to the sound processing apparatus 100, or a communication device that receives the sound signal SA(t) from a communication network and supplies the received sound signal SA(t) to the sound processing apparatus 100 as the signal supply device 12.

The sound processing apparatus 100 according to the first embodiment of the invention is a signal processing apparatus (sound source separation apparatus) that generates a sound signal SB(t) by separating the sound signal SA(t) supplied from the signal supply device 12 a sound source by sound source basis. The sound signal SB(t) represents the time waveform of one sound selected from a sound of the first sound source and a sound of the second sound source, which are included in the sound signal SA(t). Specifically, the sound signal SB(t), which represents a sound component of a sound source selected by a user from the first sound source and the second sound source, is provided to the sound output device 14. That is, the sound signal SA(t) is separated a sound source by sound source basis. The sound output device 14 (for example, a speaker or a headphone) emits sound waves in response to the sound signal SB(t) supplied from the sound processing apparatus 100. An analog-to-digital converter that converts the sound signal SA(t) from an analog form to a digital form and a digital-to-analog converter that converts the sound signal SB(t) from a digital form to an analog form are omitted from the figure for convenience.

As shown in FIG. 1, the sound processing apparatus 100 is expressed as a computer system including an execution processing device 22 and a storage device 24. The storage device 24 stores a program PGM executed by the execution processing device 22 and information (for example, basis matrix F) used by the execution processing device 22. A known storage medium such as a semiconductor storage medium, a magnetic storage medium or the like, or a combination of storage media of a plurality of types can be used as the storage device 24. It is desirable to employ a configuration in which the sound signal SA(t) is stored in the storage device 24 (and thus the signal supply device 12 can be omitted).

The storage device 24 according to the first embodiment of the invention stores a basis matrix F that represents characteristics of a sound of the known first sound source. The first sound source can be expressed as a sound source in which the basis matrix F has been prepared or learned. The sound processing apparatus 100 generates the sound signal SB(t) according to unsupervised sound source separation using the basis matrix F stored in the storage device 24 as advance information. The basis matrix F is previously generated from a sound (hereinafter referred to as a learning sound) generated from the known first sound source alone and stored in the storage device 24. The learning sound does not include a sound of the second sound source.

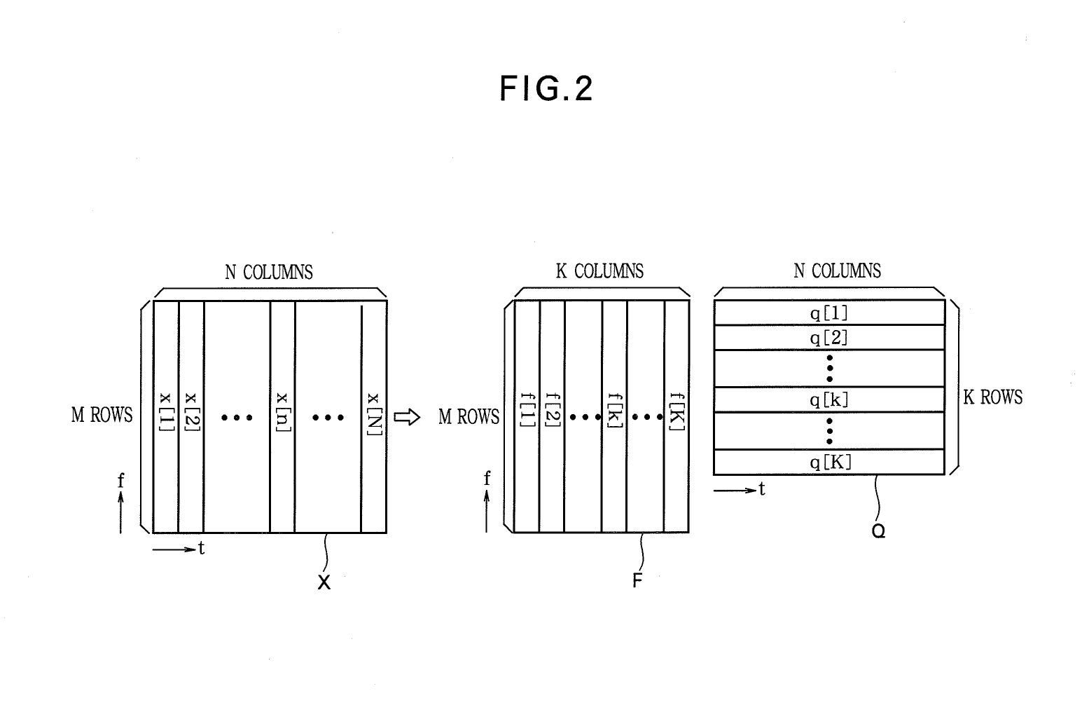

FIG. 2 illustrates a process of generating the basis matrix F from the learning sound generated from the first sound source. An observation matrix X shown in FIG. 2 is an N×M non-negative matrix (M and N being natural numbers) that represents time series of amplitude spectra of N frames (amplitude spectrogram) obtained by dividing the learning sound of the first sound source on the time domain. That is, an n-th column (n=1 to N) of the observation matrix X corresponds to an amplitude spectrum x[n] of an n-th frame of the learning sound. An element of an m-th row (m=1 to M) of the amplitude spectrum x[n] corresponds to the amplitude of an m-th frequency from among M frequencies set in the frequency domain.

The observation matrix X shown in FIG. 2 is decomposed into the basis matrix F and a coefficient matrix (activation matrix) Q according to non-negative matrix factorization (NMF) as represented by the following expression (1).

X≈FQ (1)

As shown in FIG. 2, the basis matrix F in expression (1) is an M×K non-negative matrix in which K basis vectors f[1] to f[K] respectively corresponding to components of the learning sound of the first sound source are arranged in the horizontal direction. In the basis matrix F, a basis vector f[k] of a k-th column (k=1 to K) corresponds to the amplitude spectrum of a k-th component from among K components (bases) constituting the learning sound. That is, an element of the m-th row (more concretely an element at a cross point between the k-th column and the m-th row of the basis matrix F) of the basis vector f[k] corresponds to the amplitude of an m-th frequency on the frequency domain from among the amplitude spectrum of the k-th component of the learning sound.

As shown in FIG. 2, the coefficient matrix Q in expression (1) is a K×N non-negative matrix in which K coefficient vectors q[1] to q[K] respectively corresponding to the basis vectors f[k] of the basis matrix F are arranged in the vertical direction. A coefficient vector q[k] of a k-th row of the coefficient matrix Q corresponds to time series of a weight (activity) for the basis vector f[k] of the basis matrix F.

The basis matrix F and the coefficient matrix Q are computed such that a matrix FQ obtained by multiplying the basis matrix F by the coefficient matrix Q approximates the observation matrix X (that is, a difference between the matrix FQ and the observation matrix X is minimized), and the basis matrix F is stored in the storage device 24. The K basis vectors f[1] to f[K] of the basis matrix F approximately correspond to different pitches of the learning sound of the first sound source. Accordingly, the learning sound used to generate the basis matrix F is generated such that it includes all pitches that can be considered to correspond to sound components of the first sound source, in the sound signal SA(t) that is to be separated, and the total number K (the number of bases) of the basis vectors f[k] of the basis matrix F is set to a value greater than the total number of pitches that can be considered to correspond to the sound components of the first sound source, in a sound signal SA(t). The sequence of generating the basis matrix F has been described.

The execution processing device 22 shown in FIG. 1 implements a plurality of functions (frequency analysis unit 32, a matrix factorization unit 34, and a sound generation unit 36) which generate the sound signal SB(t) from the sound signal SA(t) by executing the program PGM stored in the storage device 24. Processes according to the components of the execution processing device 22 are sequentially repeated on the basis of N frames obtained by dividing the sound signal SA(t) in the time domain. Meantime, it is possible to employ a configuration in which the functions of the execution processing device 22 are distributed in a plurality of integrated circuits or a configuration in which a dedicated electronic circuit (DSP) implements some functions.

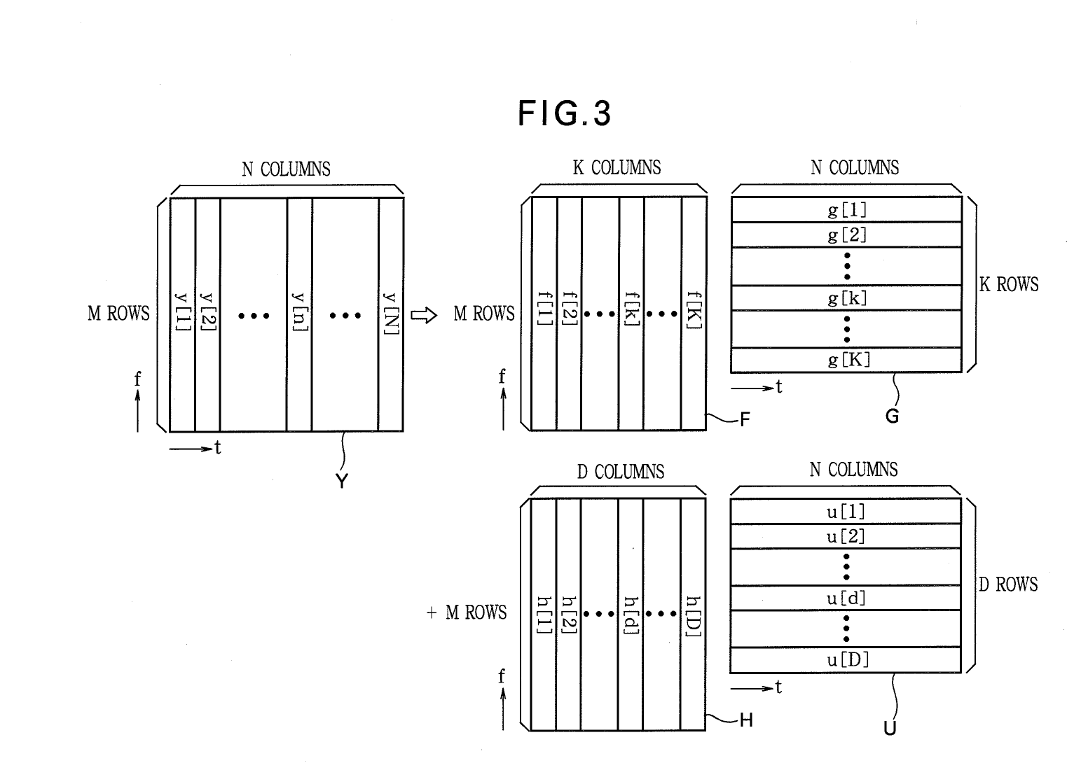

FIG. 3 illustrates processing according to the frequency analysis unit 32 and the matrix factorization unit 34. The frequency analysis unit 32 generates an observation matrix Y on the basis of the N frames of the sound signal SA(t). As shown in FIG. 3, the observation matrix Y is an M×N non-negative matrix that represents time series of amplitude spectra of the N frames (amplitude spectrogram) obtained by dividing the sound signal SA(t) in the time domain. That is, an n-th column of the observation matrix Y corresponds to an amplitude spectrum y[n] (series of amplitudes of M frequencies) of an n-th frame in the sound signal SA(t). For example, a known frequency analysis scheme such as short-time Fourier transform is used to generate the observation matrix Y.

The matrix factorization unit 34 shown in FIG. 1 executes non-negative matrix factorization (NMF) of the observation matrix Y using the known basis matrix F stored in the storage device 24 as advance information. In the first embodiment of the invention, the observation matrix Y acquired by the frequency analysis unit 32 is decomposed into the basis matrix F, a coefficient matrix G, a basis matrix H and a coefficient matrix U, as represented by the following expression (2).

Y≈FG+HU (2)

As described above, since the characteristics of the learning sound of the first sound source are reflected in the basis matrix F, the basis matrix F and the coefficient matrix G correspond to sound components of the first sound source, which are included in the sound signal SA(t). The basis matrix H and the coefficient matrix U correspond to sound components of a sound source (that is, the second sound source) other than the first sound source, which are included in the sound signal SA(t).

As described above, the known basis matrix F stored in the storage device 24 is an M×N non-negative matrix in which K basis vectors f[1] to f[K] respectively corresponding to the sound components of the first sound source are arranged in the horizontal direction. As shown in FIG. 3, the coefficient matrix (activation matrix) G in expression (2) is a K×N non-negative matrix in which K coefficient vectors g[1] to g[K] corresponding to the basis vectors f[k] of the basis matrix F are arranged in the vertical direction. A coefficient vector g[k] of a k-th column of the coefficient matrix G corresponds to time series of a weight (activity) with respect to the basis vector f[k] of the basis matrix F. That is, an element of an n-th column of the coefficient vector g[k] corresponds to the magnitude (weight) of the basis vector f[k] of the first sound source in the n-th frame of the sound signal SA(t). As is understood from the above description, the matrix FG of the first term of the right side of expression (2) is an M×N non-negative matrix that represents the amplitude spectra of the sound components of the first sound source, which are in the sound signal SA(t).

As shown in FIG. 3, the basis matrix H of expression (2) is an M×D non-negative matrix in which D basis vectors h[1] to h[D] respectively corresponding to sound components of the second sound source, which are included in the sound signal SA(t), are arranged in the horizontal direction. The number K of columns of the basis matrix F and the number D of columns of the basis matrix H may be equal to or different from each other. Like the basis matrix F, a basis vector h[d] of a d-th column (d=1 to D) of the basis matrix H corresponds to the amplitude spectrum of a d-th component from among D components (bases) constituting the sound components of the second sound source, which are included in the sound signal SA(t). That is, an element of an m-th row of the basis vector h[d] corresponds to the amplitude of an m-th frequency in the frequency domain from among the amplitude spectrum of the d-th component constituting a sound component of the second sound source, which is included in the sound signal SA(t).

As shown in FIG. 3, the coefficient matrix U in expression (2) is a D×M non-negative matrix in which D coefficient vectors u[1] to u[D] respectively corresponding to the basis vectors h[d] of the basis matrix H of the second sound source are arranged in the vertical direction. Like the coefficient matrix G, a coefficient vector u[d] of a d-th column of the coefficient matrix U corresponds to time series of a weight with respect to the basis vector h[d] of the basis matrix H. Accordingly, a matrix HU corresponding to the second term of the right side of expression (2) is an M×N non-negative matrix that represents the amplitude spectra of the sound components of the second sound source, which are included in the sound signal SA(t).

The matrix factorization unit 34 shown in FIG. 1 generates the coefficient matrix G of the first sound source and the basis matrix H and the coefficient matrix U of the second sound source such that the condition of expression (2) that a matrix (FG+HU) corresponding to a sum of the matrix FG of the first sound source and the matrix HU of the second sound source approximates the observation matrix Y (that is, a difference between the matrix FG+HU and the matrix Y is minimized). In the first embodiment, an evaluation function J represented by the following expression (3) is introduced in order to evaluate the condition of the equation (2). In the following description, an element at a j-th row and at an i-th column in an arbitrary matrix A is represented by Aᵢⱼ. For example, Gₖₙ denotes an element at an n-th column and at a k-th row.

J=∥Y−FG−HU∥_{Fr}² (3)

s.t.Gₖₙ≧0,H_{md}≧0,U_{dn}≧0 for all m,k,n,d (4)

Symbol ∥ ∥_{Fr} in equation (3) represents Frobenius norm (Euclidean distance). Condition (4) represents that the coefficient matrix G, the basis matrix H, and the coefficient matrix U are all non-negative matrices. As is known from equation (3), the evaluation function J decreases as the sum of the matrix FG of the first sound source and the matrix HU of the second sound source becomes close to the observation matrix Y (as approximation error decreases). In view of this, the coefficient matrix G, the basis matrix H and coefficient matrix U are generated such that the evaluation function J is minimized.

When the Frobenius norm in expression (3) is modified by replacing it by the trace of a matrix, the following expression (5) is derived. In expression (5), T represents a transpose of a matrix and tr{ } denotes the trace of a matrix.

$$\begin{matrix}J = tr \{ ( Y - FG - HU ) {( Y - FG - HU )}^{T} \} \\ = tr \{ {YY}^{T} \} - 2 tr \{ {YG}^{T} {F}^{T} \} - 2 tr ( {YU}^{T} {H}^{T} \} + 2 tr \{ {FGU}^{T} {H}^{T} \} + \\ tr \{ {HUU}^{T} {H}^{T} \} + tr \{ {FGG}^{T} {F}^{T} \}\end{matrix} \qquad ( 5 )$$

Lagrangian L represented by the following expression (6) is introduced in order to examine the evaluation function J.

L=J+tr{αH^{T}}+tr{βU^{T}}+tr{γG^{T}} (6)

Considering the aforementioned condition (4), complementary condition of KKT (Karuch Kuhn Tucker) is represented by the following expressions (7a), (7b) and (7c).

α_{md}H_{md}=0 (7a)

β_{dn}U_{dn}=0 (7b)

γₖₙGₖₙ=0 (7c)

The following expression (8) is derived by setting partial differentiation of Lagrangian L having the coefficient matrix G as an object variable to 0.

$$\frac{\partial L}{\partial G} = - 2 {F}^{T} Y + 2 {F}^{T} HU + 2 {F}^{T} FG + γ = 0 \qquad ( 8 )$$

When both sides of expression (8) are multiplied by an element Gₖₙ of an n-th column and a k-th row of the coefficient matrix G in consideration of only the component of the n-th column and the k-th row of the matrix of expression (8), the following expression (9) is derived.

[−2F^{T}Y+2F^{T}HU+2F^{T}FG+γ]ₖₙGₖₙ=0 (9)

By applying expression (7c) to expression (9), the following expression (10) is derived.

[−2F^{T}Y+2F^{T}HU+2F^{T}FG]ₖₙGₖₙ=0 (10)

The following update formula (11) for updating an element Gₖₙ of the coefficient matrix G is derived by modifying expression (10).

$${G}_{kn} = \frac{{[ {F}^{T} Y ]}_{kn}}{{[ {F}^{T} HU + {F}^{T} FG ]}_{kn}} {G}_{kn} \qquad ( 11 )$$

Similarly, the following update formula (12) that updates an element H_{md} of the basis matrix H is derived by applying expression (7a) with partial differentiation of Lagrangian L having the basis matrix H as an object variable set to 0.

$${H}_{md} = \frac{{[ {YU}^{T} ]}_{md}}{{[ {FGU}^{T} + {HUU}^{T} ]}_{md}} {H}_{md} \qquad ( 12 )$$

The following update formula (13) that updates an element U_{dn} of the coefficient matrix U is derived by applying expression (7b) with partial differentiation of Lagrangian L having the coefficient matrix U as an object variable set to 0.

$${U}_{dn} = \frac{{[ {H}^{T} Y ]}_{dn}}{{[ {H}^{T} HU + {H}^{T} FG ]}_{dn}} {U}_{dn} \qquad ( 13 )$$

The matrix factorization unit 34 shown in FIG. 1 repeats computations of update formulas (11), (12) and (13) and determines computation results (Gₖₙ, H_{md} and U_{dn}), obtained when the number of repetitions reaches a predetermined number R, as the coefficient matrix G, the basis matrix H and the coefficient matrix U. The number R of computations of expressions (11), (12) and (13) is experimentally or statistically selected such that the evaluation function J reaches 0 or converges to a predetermined value during R repetitions. Initial values of the coefficient matrix G (element Gₖₙ), the basis matrix H (element H_{md}) and the coefficient matrix U (element U_{dn}) are set to random numbers, for example. As is understood from the above description, the matrix factorization unit 34 generates the coefficient matrix G, the basis matrix H and the coefficient matrix U that satisfy expression (2) for the acquired observation matrix Y and the acquired basis matrix F of the sound signal SA(t).

The sound generation unit 36 shown in FIG. 1 generates the sound signal SB(t) using the matrices G, H and U generated by the matrix factorization unit 34. Specifically, when the first sound source is designated, the sound generation unit 36 computes the amplitude spectrogram of the sound of the first sound source, which is included in the sound signal SA(t), by multiplying the basis matrix F acquired from the storage device 24 by the coefficient matrix G generated by the matrix factorization unit 34, and generates the sound signal SB(t) of the time domain through inverse Fourier transform which employs the amplitude spectrum of each frame and the phase spectrum at the frame of the sound signal SA(t). When the second sound source is designated, the sound generation unit 36 computes the amplitude spectrogram of the sound of the second sound source, which is included in the sound signal SA(t), by multiplying the basis matrix H generated by the matrix factorization unit 34 by the coefficient matrix U, and generates the sound signal SB(t) of the time domain using the amplitude spectrum of each frame and the phase spectrum at the frame of the sound signal SA(t). That is, the sound signal SB(t) is generated by separating the sound signal SA(t) among different sound sources. The sound signal SB(t) generated by the sound generation unit 36 is supplied to the sound output device 14 and reproduced as sound waves. Meanwhile, it is possible to generate both the sound signal SB(t) of the first sound source and the sound signal SB(t) of the second sound source and perform respective sound processing for the sound signals SB(t).

In the first embodiment described above, since the coefficient matrix G of the first sound source and the basis matrix H and the coefficient matrix U of the second sound source are generated through non-negative matrix factorization of the observation matrix Y using the known basis matrix F of the first sound source, a sound component of the first sound source, included in the sound signal SA(t), is reflected in the matrix FG and a sound component of the second sound source, included in the sound signal SA(t), is reflected in the matrix HU. That is, the matrix FG corresponding to the first sound source and the matrix HU corresponding to the second sound source are individually specified. Therefore, it is possible to separate the sound signal SA(t) by respective sound sources, in manner distinguished from Non-Patent Reference 1 and Non-Patent Reference 2.

### Second Embodiment

A second embodiment of the invention will now be described. In each embodiment illustrated below, elements whose operations or functions are similar to those of the first embodiment will be denoted by the same reference numerals as used in the above description and a detailed description thereof will be omitted as appropriate.

In the first embodiment, the basis vector h[d] of the basis matrix H computed by the matrix factorization unit 34 may become equal to the basis vector f[k] of the known basis matrix F because the correlation between the basis matrix F of the first sound source and the basis matrix H of the second sound source is not confined. When the basis vector h[d] corresponds to the basis vector f[k], one of the coefficient vector g[k] of the coefficient matrix G and the coefficient vector u[d] of the coefficient matrix U converges into a zero vector in order to establish expression (2). However, a sound component of the first sound source, which corresponds to the basis vector f[k], is omitted from the sound signal SB(t) when the coefficient vector g[k] is a zero vector whereas a sound component of the second sound source, which corresponds to the basis vector h[d], is omitted from the sound signal SB(t) when the coefficient vector u[d] is a zero vector. In view of this, in the second embodiment of the invention, the matrix factorization unit 34 generates the coefficient matrix G of the first sound source and the basis matrix H and the coefficient matrix U of the second sound source such that the correlation between the basis matrix F of the first sound source and the basis matrix H of the second sound source decreases (ideally the basis matrix F of the first sound source and the basis matrix H of the second sound source do not correlate with each other).

To evaluate the correlation (similarity) between the basis matrix F and the basis matrix H, a correlation matrix F^{T}H of the basis matrix F and the basis matrix H is introduced. The correlation matrix F^{T}H becomes closer to a zero matrix as the correlation between each basis vector f[k] of the basis matrix F and each basis vector h[d] of the basis matrix H decreases (for example, each basis vector f[k] and each basis vector h[d] are orthogonal). Accordingly, the matrix factorization unit 34 in the second embodiment generates the coefficient matrix G, the basis matrix H and the coefficient matrix U under the condition that the correlation matrix F^{T}H approximates a zero matrix (ideally, corresponds to a zero matrix).

To evaluate the condition that the correlation matrix F^{T}H approximates a zero matrix along with the condition of expression (2), an evaluation function J of the following expression (3A) obtained by adding the square ∥F^{T}H∥_{Fr}² of the Frobenius norm of the correlation matrix F^{T}H to expression (3) as a penalty term is introduced. That is, the evaluation function J in the second embodiment includes a first term (hereinafter referred to as ‘error term’) ∥Y−FG−HU∥_{Fr}², which represents a degree by which the observation matrix Y differs from the matrix FG+HU corresponding to the sum of the matrix FG of the first sound source and the matrix HU of the second sound source, and a second term (hereinafter referred to as ‘correlation term’) ∥F^{T}H∥_{Fr}², which represents the correlation between the basis matrix F and the basis matrix H.

J=∥Y−FG−HU∥_{Fr}²+∥F^{T}H_{Fr}² (3A)

The correlation term of expression (3A) decreases as the correlation between the basis matrix F and the basis matrix H decreases. In view of this, the coefficient matrix G of the first sound source and the basis matrix H and the coefficient matrix U of the second sound source are generated such that the evaluation function J of expression (3A) is minimized. The aforementioned condition (4) is equally applied in the second embodiment.

When the Frobenius norm of expression (3A) is modified by replacing the same by the trace of a matrix, the following expression (5A) is derived.

$$\begin{matrix}J = tr \{ ( Y - FG - HU ) {( Y - FG - HU )}^{T} \} + tr \{ {F}^{T} {HH}^{T} F \} \\ = tr \{ {YY}^{T} \} - 2 tr \{ {YG}^{T} {F}^{T} \} - 2 tr \{ {YU}^{T} {H}^{T} \} + 2 tr \{ {FGU}^{T} {H}^{T} \} + \\ tr \{ {HUU}^{T} {H}^{T} \} + tr \{ {FGG}^{T} {F}^{T} \} + tr \{ {F}^{T} {HH}^{T} F \}\end{matrix} \qquad ( 5 A )$$

As in the first embodiment, the following update formula (12A) that sequentially updates the element H_{md} of the basis matrix H is derived by setting the Lagrangian L of expression (6) that employs expression (5A) as the evaluation function J to 0 through partial differentiation at the basis matrix H and applying expression (7a). An update formula of the element Gₖₙ of the coefficient matrix G corresponds to expression (11) and an update formula of the element U_{dn} of the coefficient matrix U corresponds to expression (13).

$${H}_{md} = \frac{{[ {YU}^{T} ]}_{md}}{{[ {FGU}^{T} + {HUU}^{T} + {FF}^{T} H ]}_{md}} {H}_{md} \qquad ( 12 A )$$

The matrix factorization unit 34 according to the second embodiment repeats the computations of expressions (11), (12A) and (13) and fixes computation results, obtained when the number of repetitions reaches R, as the coefficient matrix G, the basis matrix H and the coefficient matrix U. The number R of repetitions and the initial values of the matrices correspond to those used in the first embodiment. As is understood from the above description, the coefficient matrix G of the first sound source and the basis matrix H and the coefficient matrix U of the second sound source are generated such that the matrix FG+HU corresponding to the sum of the matrix FG and the matrix HU approximates the observation matrix Y and the correlation between the basis matrix F and the basis matrix H decreases (ideally, the basis matrix F and the basis matrix H do not correlate with each other).

In the second embodiment, the same effect as the first embodiment is achieved. Furthermore, in the second embodiment, the coefficient matrix G, the basis matrix H and the coefficient matrix U are generated such that the correlation between the basis matrix F and the basis matrix H decreases. That is, the basis vector h[d] corresponding to the basis vector f[k] of the known basis matrix F is not present in the basis matrix H of the second sound source. Accordingly, the possibility that one of the coefficient vector g[k] of the coefficient matrix G and the coefficient vector u(d) of the coefficient matrix U converges into a zero vector is reduced, and thus it is possible to prevent a sound component from being omitted from the sound signal SB(t).

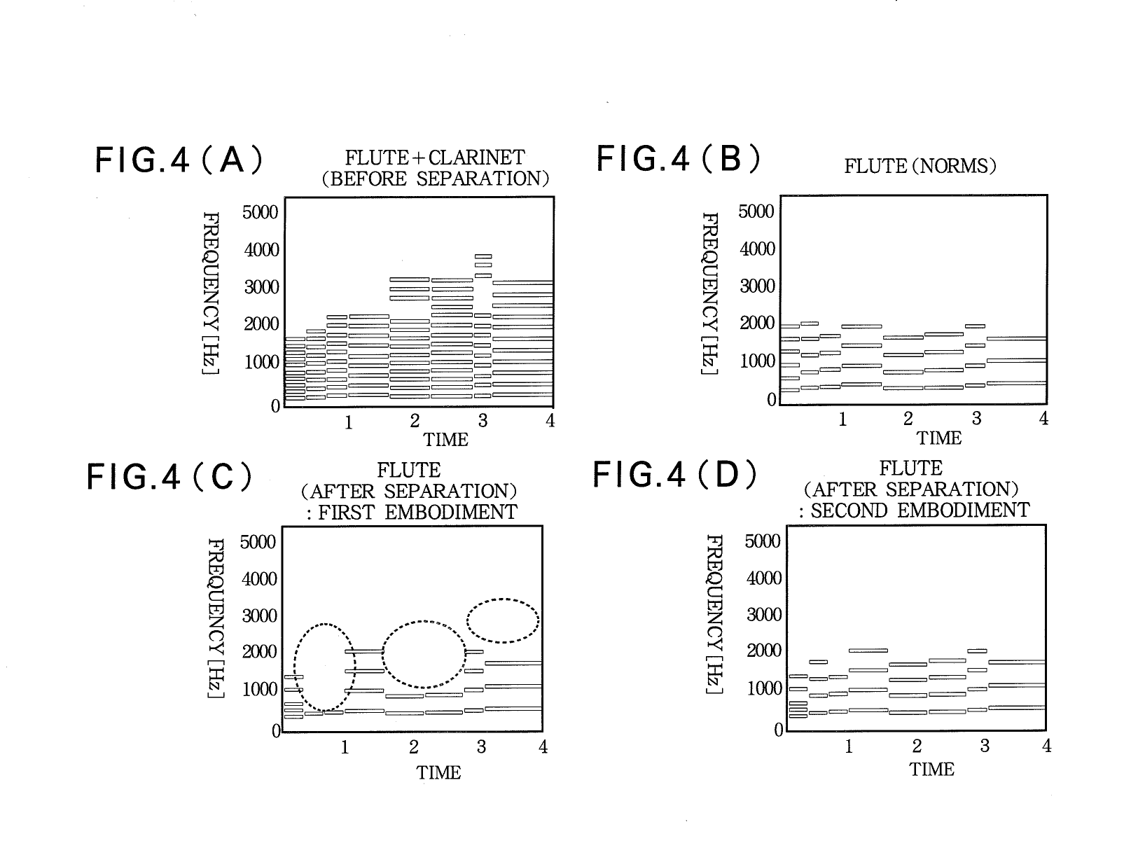

FIGS. 4(A)-4(D) illustrate effects of the second embodiment compared to the first embodiment. In the following description, it is assumed that the first sound source is a flute whereas the second sound source is a clarinet and a flute sound is separated as the sound signal SB(t) from the sound signal SA(t). FIG. 4(A) is an amplitude spectrogram of the sound signal SA(t) when musical tones of tunes having common scales are generated in parallel in a sound source circuit for the flute and the clarinet (unison). FIG. 4(B) is an amplitude spectrogram when a musical tone of the same tune is generated for only the flute (that is, the norm of the amplitude spectrogram of the sound signal SB(t)).

FIG. 4(C) shows the amplitude spectrogram of the sound signal SB(t) generated in the first embodiment. Comparing FIG. 4(C) with FIG. 4(B), it can be confirmed that in the configuration of the first embodiment, the sound signal SB(t) does not include some parts indicated by dotted lines in FIG. 4(C) of the sound of the first sound source, included in the sound signal SA(t), after being separated.

FIG. 4(D) shows the amplitude spectrogram of the sound signal SB(t) generated in the second embodiment. As shown in FIG. 4(D), according to the second embodiment, omission of the sound of the first sound source from the sound signal SB(t) is restrained, compared to the first embodiment, and it can be confirmed that a flute sound corresponding to FIG. 4(B) can be extracted with high accuracy. As described above, according to the second embodiment, it is possible to separate the sound signal SA(t) by respective sound sources with high accuracy while preventing omission of sound of each sound source after separation.

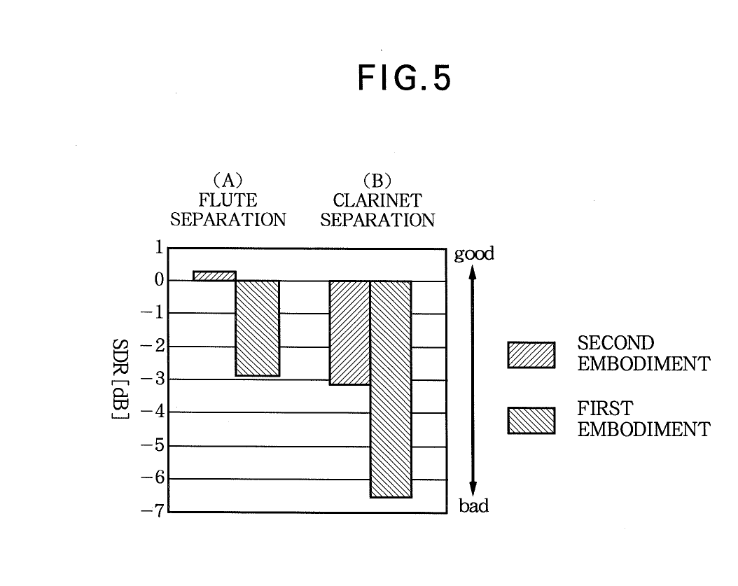

FIG. 5 shows measurement values of signal-to-distortion ratio (SDR) of the sound signal SB(t) after separation in the first and second embodiments. A sound of a target sound source is separated with high accuracy, and SDR increases as waveform distortion is small before and after separation. In FIG. 5, it is assumed that the first sound source corresponds to a flute whereas the second sound source corresponds to a clarinet.

Part (A) of FIG. 5 shows measurement values of SDR when a flute sound is extracted as the sound signal SB(t) and part (B) of FIG. 5 shows measurement values of SDR when a clarinet sound is extracted as the sound signal SB(t). In a case that either of the flute sound and the clarinet sound is extracted, it is possible to quantitatively confirm that the SDR of the second embodiment exceeds that of the first embodiment. That is, according to the second embodiment, it is possible to separate the sound signal SA(t) into respective sound sources with high accuracy while preventing omission of sound of each sound source after sound separation, compared to the first embodiment.

### Third Embodiment

In the evaluation function J of expression (3A) exemplified in the second embodiment, the values of the error term ∥Y−FG−HU∥_{Fr}² and correlation term ∥F^{T}H∥_{Fr}² may be considerably different from each other. That is, degrees of contribution of the error term and correlation term to increase/decrease of the evaluation function J can remarkably differ from each other. For example, when the error term is remarkably larger than the correlation term, the evaluation function J is sufficiently reduced if the error term decreases, and thus there is a possibility that the correlation term is not sufficiently reduced. Similarly, the error term may not sufficiently decrease if the correlation term is considerably larger than the error term.

Accordingly, in the third embodiment, the error term and the correlation term of the evaluation function J approximate each other. Specifically, an evaluation function K represented as the following expression (3B), which is obtained by adding a predetermined constant λ (hereinafter referred to as ‘adjustment factor’) to the correlation term ∥F^{T}H∥_{Fr}² relating to the correlation between the basis matrix F and the basis matrix H, is introduced.

J=∥Y−FG−HU∥_{Fr}²+λ∥F^{T}H∥_{Fr}² (3B)

The adjustment factor λ of expression (3B) is experimentally or statistically set such that the error term and the correlation term approximate (balance) each other. Furthermore, it is possible to experimentally compute the error term and the correlation term and optimally set the adjustment factor λ such that the difference between the error term and the correlation term decreases. When the evaluation function J of expression (3B) is used, the update formula of the element H_{md} of the basis matrix H is defined as the following expression (12B) including the adjustment factor λ.

$${H}_{md} = \frac{{[ {YU}^{T} ]}_{md}}{{[ {FGU}^{T} + {HUU}^{T} + λ {FF}^{T} H ]}_{md}} {H}_{md} \qquad ( 12 B )$$

The third embodiment achieves the same effects as those of the first embodiment and the second embodiment. Furthermore, in the third embodiment, because the error term ∥Y−FG−HU∥_{Fr}² and correlation term ∥F^{T}H∥_{Fr}² of the evaluation function J are adjusted according to the adjustment factor λ, the condition that the error term is reduced and the condition that the correlation term is decreased consist with each other. Therefore, the effect of the second embodiment that the sound signal SA(t) can be separated into respective sound sources with high accuracy is achieved by the third embodiment while preventing partial omission of sound becomes conspicuous. While the adjustment factor λ is added to the correlation term of the evaluation function J in the above description, it is possible to employ both a configuration in which the adjustment factor λ is added to the error term and a configuration in which the adjustment factors A are respectively added to the error term and the correlation term.

### Fourth Embodiment

The second embodiment sets the constraint that the correlation between the basis matrix F of the first sound source and the basis matrix H of the second sound source lowers. Meanwhile, the fourth embodiment generates the coefficient matrix G of the first sound source, the basis matrix H of the second sound source and the coefficient matrix U of the second sound source under the constraint that a distance between the basis matrix F of the first sound source and the basis matrix H of the second sound source increases (ideally becomes maximum).

The fourth embodiment introduces an evaluation function J represented by the following expression (3C) instead of the evaluation function J represented by the before noted expression (3A). As described before, according to the condition (4), the coefficient matrix G, the basis matrix H and the coefficient matrix U are a non-negative matrix.

J=δ(Y|FG+HU)−δ(F|H) (3C)

The notation δ(x|y) contained in the expression (3C) means a distance between a matrix x and a matrix y (distance norm). Namely, the evaluation function J represented by the expression (3C) is formed of an error term δ(Y|FG+HU) and a correlation term δ(F|H). The error term represents a distance (a degree of error) between the observation matrix Y and a sum of the matrix FG of the first sound source and the matrix HU of the second sound source, and the correlation term represents a distance between the basis matrix F and the basis matrix H.

The distance δ(F|H) may be one of various types such as Frobenius norm (Euclidean distance), IS (Itakura-Saito) divergence and β divergence. In the following embodiment, the distance δ(F|H) is exemplified by I divergence (generalized KL divergence) represented by the following expression (13).

$$δ ( x \vert y ) = x log ( \frac{x}{y} ) - ( x - y ) \qquad ( 13 )$$

As understood by the expression (3C), the evaluation function J decreases as the distance δ(F|H) between the basis matrix F and the basis matrix H increases (namely, similarity decreases). In taking account of the above tendency, the fourth embodiment generates the coefficient matrix G of the first sound source, the basis matrix H of the second sound source and the coefficient matrix U of the second sound source under the constraint that the evaluation function J represented by the expression (3C) becomes minimum (namely, the distance δ(F|H) becomes maximum.

Specifically, under the condition to minimize the evaluation function J represented by the expression (3C), the expressions (14), (15) and (16) are derived for successively updating respective matrices (G, H, U).

$$\begin{matrix}H =. \frac{H}{{I}_{MN} {U}^{T} + . \frac{{FI}_{KD}}{H}} \times ( . \frac{Y}{HU + FG} {U}^{T} + K ) & ( 14 ) \\ U =. \frac{U}{{H}^{T} {I}_{MN}} . \times ( {H}^{T} . \frac{Y}{HU + FG} ) & ( 15 ) \\ G =. \frac{G}{{F}^{T} {I}_{MN}} . \times ( {F}^{T} . \frac{Y}{HU + FG} ) & ( 16 )\end{matrix}$$

In the expressions (14), (15) and (16), the notation .A/B indicates division of each element of matrix A by each element of matrix B, and the notation A.×B indicates multiplication of each element of matrix A by each element of matrix B. Further, the matrix I_{xy} indicates a matrix being composed of x rows and y columns and having all elements 1. In the fourth embodiment, the matrix factorization unit 34 calculates unknown basis matrix H by repetitive computation of the expression (14), calculates unknown coefficient matrix U by repetitive computation of the expression (15) and calculates unknown coefficient matrix G by repetitive computation of the expression (16). The number of times of repetitive computation and initial values of the respective matrices are set in manner identical to the first embodiment.

The fourth embodiment achieves the same effects as those of the second embodiment. The constraint adopted in the second embodiment and the constraint adopted in the fourth embodiment are generalized to a general constraint that similarity between the known basis matrix F and the unknown basis matrix H should be reduced. Namely, the general constraint that the similarity between the basis matrix F and the basis matrix H be reduced should include a specific constraint (the second embodiment) that the correlation between the basis matrix F and the basis matrix H be reduced, and anther specific constraint (the fourth embodiment) that the distance between the basis matrix F and the basis matrix H be increased.

The fourth embodiment also may apply the adjustment factor λ introduced in the third embodiment to the evaluation function used in the fourth embodiment. The evaluation function to which the adjustment factor λ is applied may be represented for example by the following expression (3D). Further, the before-described expression (14) used for computation of unknown basis matrix H is replaced by the following expression (14A).

$$\begin{matrix}J = δ ( Y \vert FG + HU ) - λ δ ( F \vert H ) & ( 3 D ) \\ H =. \frac{H}{{I}_{MN} {U}^{T} + λ . \frac{{FI}_{KD}}{H}} \times ( . \frac{Y}{HU + FG} {U}^{T} + λ K ) & ( 14 A )\end{matrix}$$

In the expression (3D), the adjustment factor λ is added to the correlation term δ(F|H). Alternatively, the adjustment factor λ may be added to the error term δ(Y|FG+HU), or respective adjustment factors λ may be added to the correlation term δ(F|H) and the error term δ(Y|FG+HU).

<Modifications>

Various modifications can be made to each of the above embodiments. The following are specific examples of such modifications. Two or more modifications arbitrarily selected from the following examples may be appropriately combined.

(1) In each of the above embodiments, while the basis matrix F is generated according to non-negative matrix factorization of the observation matrix X, the method of generating the basis matrix F is arbitrary. Since the basis matrix F is composed of K amplitude spectra regarded as sound of the first sound source, it is possible to generate the basis matrix F by computing an average amplitude spectrum of the sound of the first sound source for K pitches and arranging K amplitude spectra respectively corresponding to the pitches. That is, an arbitrary technology of specifying the amplitude spectrum of a sound is used to generate the basis matrix F.

(2) In each of the above embodiments, while non-negative matrix factorization employing Frobenius norm is exemplified, distance criteria applied to the non-negative matrix factorization are not limited to Frobenius norm. Specifically, a known distance criterion such as Kullback-Leibler distance and divergence can be employed. It is also possible to employ non-negative matrix factorization employing sparseness constraints.

(3) In each of the above embodiments, the sound signal SA(t) is separated into the first sound source and the second sound source other than the first sound source using the basis matrix F of the known first sound source. However, the present invention can be equally applied to a case in which the sound signal SA(t) is separated into two or more known sound sources and a sound source other than the known sound sources using basis matrices of the known two or more sound sources. For example, when first, second and third sound sources are present, on the assumption that the basis matrix F of the first sound source and a basis matrix E of the third sound source are previously stored in the storage device 24, the coefficient matrix G of the first sound source, the basis matrix H and the coefficient matrix U of the second sound source, and a coefficient matrix V of the third sound source are computed such that a matrix corresponding to the sum of the matrix FG of the first sound source, matrix HU of the second sound source (one sound source other than the first sound source and the third sound source) and matrix EV of the third sound source approximates the observation matrix Y as shown in the following expression (2A).

Y≈FG+HU+EV (2A)

When three sound sources are considered in the second embodiment, the matrix factorization unit 34 generates the unknown matrices G, H, U and V such that constraints (E^{T}H=0) that a correlation matrix E^{T}H of the known basis matrix E and unknown basis matrix H becomes a zero matrix is satisfied in addition to constraints (F^{T}H=0) that the correlation matrix F^{T}H of the known basis matrix F and unknown basis matrix H becomes a zero matrix.

In analogous manner, when three sound sources are considered in the fourth embodiment, the matrix factorization unit 34 generates the unknown matrices G, H, U and V such that constraints that a distance δ(E|H) between the basis matrix E and the basis matrix H decreases is satisfied in addition to constraints that the distance δ(F|H) between the basis matrix F and the basis matrix H decreases (becomes a zero matrix).

When it is assumed that a desired number of basis matrices Zi (i=1, 2, . . . ) are known, the matrix factorization unit 34 performs processing according to the following expression (17) which is a generalized form of the before described expression (2) or expression (2A).

Y≈WA+HU (17)

The basis matrix W involved in the expression (17) is a large matrix (W=[Z1, Z2, . . . ). The matrix A is a matrix arranging therein a plurality of coefficient matrices corresponding to the respective basis matrices Zi of the large matrix W. The constraint of the second embodiment is generalized to a constraint that the correlation matrix W^{T}H between the known basis matrix W and the unknown matrix H approaches to zero (or, the Frobenius norm ∥F^{T}H∥_{Fr} of the correlation matrix W^{T}H is minimized). The constraint of the fourth embodiment is generalized to a constraint that the distance δ(W|H) between the known basis matrix W and the unknown matrix H is maximized).

As is understood from the above description, the matrix factorization unit 34 in each of the above embodiments is comprised as an element that generates the coefficient matrix G corresponding to the basis matrix F and the basis matrix H and the coefficient matrix U of the second sound source different from the first sound source by executing non-negative matrix factorization, which uses the basis matrix F previously provided (learnt) with respect to the known sound source, on the observation matrix Y. That is, if an element generates the coefficient matrix G of the first sound source and the basis matrix H and coefficient matrix U of the second sound source (one or more sound sources) using the basis matrix F of the known first sound source, this element is included in the scope of the present invention not only in a case that only the basis matrix F of the first sound source is used, as described in the first embodiment, but also in a case that a basis matrix (basis matrix E of the third sound source in expression (2A)) of a known sound source is used in addition to the basis matrix F of the first sound source.

(4) In each of the above embodiments, while the sound signal SB(t) of sound of the second sound source is generated by multiplying the basis matrix H generated by the matrix factorization unit 34 by the coefficient matrix U, it is also possible to determine the difference (Y−FG) between the observation matrix Y and the matrix FG corresponding to the first sound source as the matrix HU (that is, the amplitude spectrogram of the sound of the second sound source) of the second sound source in the time domain or frequency domain. When three sound sources are present as represented by expression (2A), it is also possible to compute the matrix EV (EV=Y−FG−HU) that represents the amplitude spectrogram of the sound of the third sound source in the frequency domain or time domain by subtracting the matrix FG of the first sound source and the matrix HU of the second sound source from the observation matrix Y.

(5) In each of the above embodiments, while the overall band of the sound signal SA(t) is processed, it is possible to process a specific band of the sound signal SA(t). If only a band component regarded as a desired sound source in the sound signal SA(t) is processed, accuracy of separation of the sound source can be improved.

(6) In each of the above embodiments, computations of expression (11) and expression (12) (expressions (12A), (12B) and (13)) are repeated by the number R. A condition of stopping a repetitive computation is arbitrarily changed. Specifically, the matrix factorization unit 34 can determine whether or not to stop a repetitive computation in response to the evaluation function J computed according to expression (3) (expressions (3A) and (3B)). For example, the matrix factorization unit 34 computes the evaluation function J using the matrices G, H and U after being updated according to each computation and stops the repetitive computation when it is determined that the evaluation function J converges upon a predetermined value (for example, a difference between the previous evaluation function J and the current updated evaluation function J becomes lower than a predetermined value). In addition, it is also possible to stop the repetitive computation when the evaluation function J becomes zero.

(7) The method of setting the initial values of the coefficient matrix G, the basis matrix H and the coefficient matrix U is arbitrary. For example, if the correlation matrix F^{L}Y of the known basis matrix F and the observation matrix Y is applied as the initial value of the coefficient matrix G, the coefficient matrix G can rapidly converge.

What is claimed is:

1. A sound processing apparatus comprising:
a matrix factorization unit that acquires a non-negative first basis matrix including a plurality of basis vectors that represent spectra of sound components of a first sound source, and that acquires an observation matrix that represents time series of a spectrum of a sound signal corresponding to a mixed sound composed of a sound of the first sound source and a sound of a second sound source different from the first sound source,
the matrix factorization unit generating a first coefficient matrix, a second basis matrix and a second coefficient matrix from the observation matrix by non-negative matrix factorization using the first basis matrix, the first coefficient matrix including a plurality of coefficient vectors that represent time variations in weights for the basis vectors of the first basis matrix, the second basis matrix including a plurality of basis vectors that represent spectra of sound components of the second sound source, the second coefficient matrix including a plurality of coefficient vectors that represent time variations in weights for the basis vectors of the second basis matrix; and
a sound generation unit that generates at least one of a sound signal according to the first basis matrix and the first coefficient matrix and a sound signal according to the second basis matrix and the second coefficient matrix.

2. The sound processing apparatus according to claim 1, wherein the matrix factorization unit generates the first coefficient matrix, the second basis matrix and the second coefficient matrix by the non-negative magnetic factorization so as to reduce a similarity between the first basis matrix and the second basis matrix.

3. The sound processing apparatus according to claim 2, wherein the matrix factorization unit generates the first coefficient matrix, the second basis matrix and the second coefficient matrix by repetitive computation of an update formula which is set such as to converge an evaluation function which includes an error term and a correlation term, the error term representing a degree of difference between the observation matrix and a sum of the product of the first basis matrix and the first coefficient matrix and the product of the second basis matrix and the second coefficient matrix, the correlation term representing a degree of the similarity between the first basis matrix and the second basis matrix.

4. The sound processing apparatus according to claim 3, wherein the matrix factorization unit generates the first coefficient matrix, the second basis matrix and the second coefficient matrix by the repetitive computation of the update formula which is set such that the evaluation function converges, wherein at least one of the error term and the correlation term has been adjusted using an adjustment factor.

5. The sound processing apparatus according to claim 1, wherein the matrix factorization unit generates the first coefficient matrix, the second basis matrix and the second coefficient matrix by the non-negative magnetic factorization so that the generated second basis matrix is not similar to the acquired first basis matrix.

6. The sound processing apparatus according to claim 5, wherein the matrix factorization unit generates the second basis matrix by the non-negative magnetic factorization of the observation matrix so that the generated second basis matrix is not correlate to the acquired first basis matrix.

7. The sound processing apparatus according to claim 5, wherein the matrix factorization unit generates the second basis matrix by the non-negative magnetic factorization of the observation matrix so that a distance between the generated second basis matrix and the acquired first basis matrix is made maximum.

8. The sound processing apparatus according to claim 5, wherein the matrix factorization unit generates the first coefficient matrix, the second basis matrix and the second coefficient matrix by repetitive computation of an update formula which is set such as to decrease an evaluation function thereof below a predetermined value, the evaluation function including an error term and a correlation term, the error term representing a degree of difference between the observation matrix and a sum of the product of the first basis matrix and the first coefficient matrix and the product of the second basis matrix and the second coefficient matrix, the correlation term representing a degree of a similarity between the first basis matrix and the second basis matrix.

9. The sound processing apparatus according to claim 8, wherein the matrix factorization unit generates the first coefficient matrix, the second basis matrix and the second coefficient matrix by the repetitive computation of the update formula which is set such that the evaluation function decreases below the predetermined value, wherein at least one of the error term and the correlation term has been adjusted using an adjustment factor.

10. A machine readable non-transitory storage medium for use in a computer, the medium containing program instructions executable by the computer for performing sound processing comprising:
acquiring a first basis matrix that is a non-negative matrix and that includes a plurality of basis vectors that represent spectra of sound components of a first sound source;
acquiring an observation matrix that represents time series of a spectrum of a sound signal corresponding to a mixed sound composed of a sound of the first sound source and a sound of a second sound source different from the first sound source;
generating a first coefficient matrix, a second basis matrix and a second coefficient matrix from the observation matrix by non-negative matrix factorization using the first basis matrix, the first coefficient matrix including a plurality of coefficient vectors that represent time variations in weights for the basis vectors of the first basis matrix, the second basis matrix including a plurality of basis vectors that represent spectra of sound components of the second sound source, the second coefficient matrix including a plurality of coefficient vectors that represent time variations in weights for the basis vectors of the second basis matrix; and
generating at least one of a sound signal according to the first basis matrix and the first coefficient matrix and a sound signal according to the second basis matrix and the second coefficient matrix.
